(19) United States
(12) Patent Application Publication
(10) Pub. No.: US 2021/0086470 A1
(43) Pub. Date: Mar. 25, 2021

(54) SPACER FABRIC PROVIDED WITH REMOVABLE YARNS

(71) Applicant: Mackent Group Co., Ltd., Taoyuan City (TW)

(72) Inventors: Yi-Chen Lin, Taoyuan City (TW); Chang-Chi Wang, Taoyuan City (TW)

(21) Appl. No.: 17/025,787

(22) Filed: Sep. 18, 2020

Related U.S. Application Data
(60) Provisional application No. 62/903,003, filed on Sep. 20, 2019.

(51) Int. Cl. B32B 5/02; D04B 21/06; D04B 21/14; D04B 21/20; D04B 1/10

(52) U.S. Cl. CPC B32B 5/026; D04B 21/06; D04B 21/14; D10B 2403/021; D04B 1/10; B32B 2305/186; D04B 21/20

(57) ABSTRACT

A spacer fabric having removable yarns is provided. The spacer fabric includes a first fabric layer, a second fabric layer, and a middle fabric layer. The first fabric layer is formed of general-purpose yarns and the removable yarns wherein the general-purpose yarns and the removable yarns are arranged to a weft-knitted loop construction according to a predetermined pattern The middle fabric layer is formed of wave-like fibers interlocked with the first fabric layer and the second fabric layer. The predetermined pattern appears on the first fabric layer after the removable yarns are removed.

The present application is filed as a non-provisional and claims the priority filing date and benefit based upon the following provisional patent applications: Ser. No. 62/903,003 filed Sep. 20, 2019, which are incorporated herein by reference in their entirety.

### BACKGROUND OF THE INVENTION

### 1. Technical Field

The present invention relates to knitted fabrics and, more particularly, to a spacer fabric provided with removable yarns.

### 2. Description of Related Art

Spacer fabrics are a three-dimensional knitted fabric consisting of two fabric layers which are separate knitted and joined by spacer yarns. The spacer yarns can be made of monofilament or multifilament yarns. Such a three-layer structure makes the spacer fabrics also well-known as “sandwich fabrics.” The spacer fabrics are thus characterized as permeability to moisture and heat and widely applied to make brasseries, underwear, sportswear, etc.

### SUMMARY OF THE INVENTION

It is, therefore, an object of this invention to provide a spacer fabric provided with removable yarns. According to the present invention, the spacer fabric employs removable yarns knitted with the general-purpose yarns such that a predetermined pattern such as openings or pleats, appears on at least one surface of the spacer fabric after the removable yarns are removed.

Accordingly, one embodiment of the present invention provides a spacer fabric, comprising: a first fabric layer formed of general-purpose yarns and removable yarns, wherein said general-purpose yarns and said removable yarns are arranged to a weft-knitted loop construction according to a predetermined pattern; a second fabric layer; and a middle fabric layer formed of wave-like fibers interlocked with said first fabric layer and said second fabric layer; wherein said predetermined pattern appears on the first fabric layer after said removable yarns are removed.

Another embodiment of the present invention provides a spacer fabric, comprising: a first fabric layer formed of general-purpose yarns and removable yarns; a second fabric layer; and a middle fabric layer having wave-like fibers and channels, said wave-like fibers being interlocked with said first fabric layer and said second fabric layer; wherein each of said removable yarns is arranged over corresponding one side of said channels according to a predetermined pattern; wherein said predetermined pattern appears on the first fabric layer after the removable yarns are removed.

### BRIEF DESCRIPTION OF THE DRAWINGS

The structure and advantages of the present invention will be best understood by referring to the following detailed description of an illustrative embodiment in conjunction with the accompanying drawings, in which:

FIG. 1 is a perspective view schematically showing the spacer fabric in accordance with the first preferred embodiment of the present invention;

FIG. 2 is an enlarged view schematically showing a weft-knitted loop construction of the first fabric layer in accordance with the first preferred embodiment of the present invention;

FIG. 3 is a structural notation diagram of FIG. 2;

FIG. 4 is an effect diagram of the predetermined pattern in accordance with the first preferred embodiment of the present invention;

FIG. 5 is a perspective view schematically showing the spacer fabric in accordance with the second preferred embodiment of the present invention; and

FIG. 6 is an effect diagram of the predetermined pattern in accordance with the second preferred embodiment of the present invention.

### DETAILED DESCRIPTION OF THE INVENTION

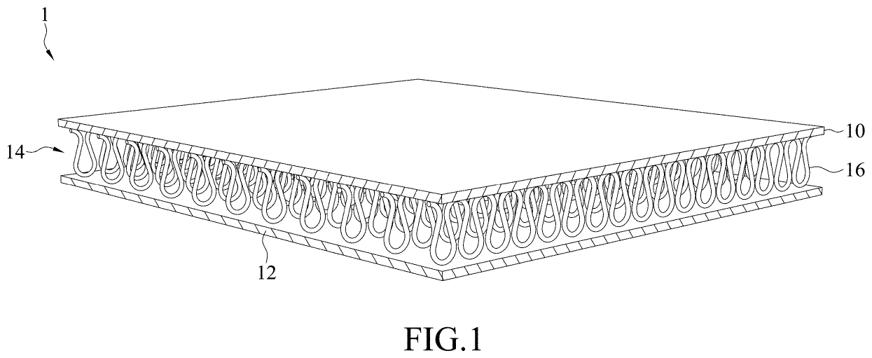

Referring to FIG. 1, a perspective view schematically shows a spacer fabric in accordance with the first preferred embodiment of the present invention. The spacer fabric 1 of the present invention includes a first fabric layer 10, a second fabric layer 12, and a middle fabric layer 14. The middle fabric layer 14 is interlocked with the first fabric layer 10 and the second fabric layer 12. The middle fabric layer 14 consists of a plurality of wave-like fibers 16. Thus, the crests of the wave-like fibers 16 are intertwined with the first fabric layer 10. The troughs of the wave-like fibers 16 are intertwined with the second fabric layer 12. It is noted that the words “crests” and “troughs” are utilized to describe the spatial relationship of the first and second fabric layers 10 and 12 as illustrated in FIG. 1; however, they cannot be construed to limit the scope of the present invention.

Moreover, the first fabric layer 10 includes general-purpose yarns and removable yarns (described in the following). The general-purpose yarns can be knitted with a material selected from a group consisting of PET (polyethylene terephthalate), polyester, nylon, PU (polyurethane) or the like and any combination thereof. Furthermore, the middle fabric layer 14 can be knitted with monofilament fibers or multifilament fibers made of a material selected from a group consisting of PET (polyethylene terephthalate), polyester, nylon, PU (polyurethane) or the like and any combination thereof. The second fabric layer 12 includes general-purpose yarns, which can be substantially knitted with a material selected from PET (polyethylene terephthalate), polyester, nylon, PU (polyurethane) or the like and any combination thereof.

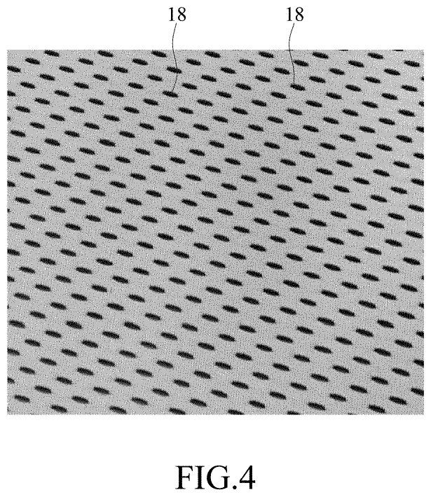

As shown in FIG. 4, a predetermined pattern such as openings 18 is intended to be formed in the first fabric layer 10 according to the first preferred embodiment of the present invention. Those openings 18 can be utilized to position the gems, crystals, or glass to increase ornamental or aesthetic effects over the spacer fabric 1. Though the openings 18 are applied to the first fabric layer 10 as shown in FIG. 4, it cannot be construed to limit the scope of the present invention. For the same reason, the openings 18 can be solely applied to the second fabric layer 12 or simultaneously applied to the first fabric layer 10 and second fabric layer 12.

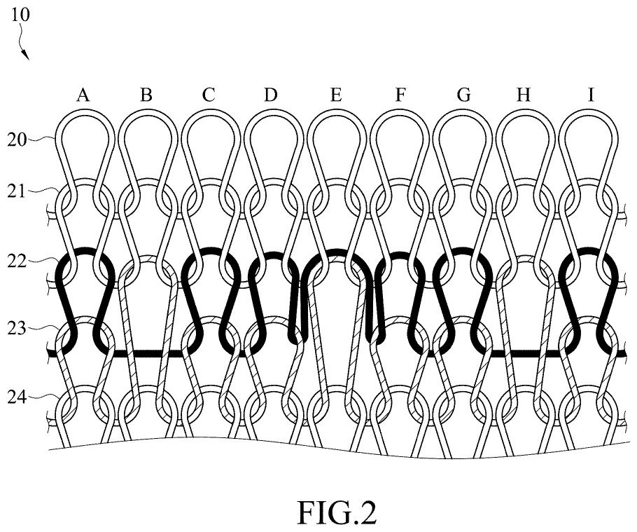

Referring to FIG. 2, an enlarged loop diagram of the first fabric layer 10 in accordance with the first preferred embodiment of the present invention. FiIG.3 is the structural notation diagram of FIG. 2.

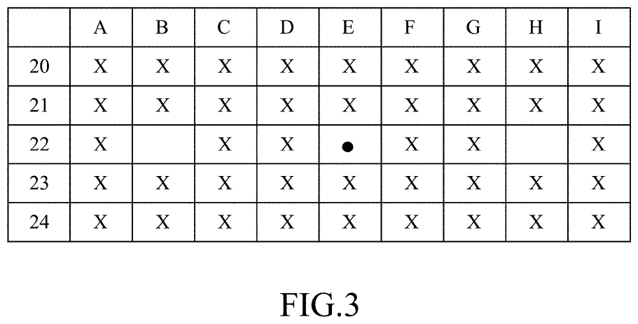

As shown in FIGS. 2-3, it is intended to form the predetermined pattern, that is, the openings 18, as shown in FIG. 4, in the first fabric layer 10. Accordingly, the loop construction of the first fabric layer 10 should be arranged according to the predetermined pattern. In FIGS. 2-3, five yarns 20-24 are provided wherein the yarns 20-21 and 23-24 are general-purpose yarns, but the yarn 22 is a removable yarn. Besides, nine columns of loops A-I are schematically depicted. According to the present invention, the spacer fabric 1 is knitted through a weft knitting machine or, preferably, a circular knitting machine. Therefore, the first fabric layer 10 is composed of weft-knitted loops. There are three basic kinds of loops, including held loops, tuck loops, and float loops. A held loop is a loop pulled through the previous course's loop and retained by the needle over one or more courses. A tuck loop is a length of yarn received by a needle but not pulled through the previous courses' loop. A float (or miss) loop is a length of yarn not received by a needle and connecting two loops of the same course that are not in adjacent wale. Accordingly, the loops 21A-21I are all held loops, and the tuck loop 22E and the held loop 23E are both intermeshed in the held loop 21E. The reference numerals 22B and 22H designate float loops such that the held loops 23B and 23H are intermeshed in the held loops 21B and 21H, respectively. As shown in FIG. 3, “X” designates a held loop, “●” designates a tuck loop, and “□” designates a float loop.

According to the first preferred embodiment of the present invention, the combination of the held loops, tuck loops, and float loops are arranged according to the predetermined pattern, as shown in FIG. 4. As above, the yarn 22 is the removable yarn which can be completely removed at a subsequent process. The removable yarn can be a water-soluble yarn, alkali-soluble yarn, easily breakable yarn, low melting temperature yarn. After the removable yarn 22 is completely removed at the subsequent process, the openings 18 are formed between the held loops 23B and 23E and further between the loops 23E and 23H in the first fabric layer 10 shown in FIG. 4.

Moreover, in consideration of structural strength between two adjacent openings 18, the yarn 23 adjacent to the removable yarn 22 can be a thermally fusible yarn. The thermal fusible yarn 23 can be slightly melted through thermal treatment to enhance the local strength at the held loops 23B, 23E, and 23H.

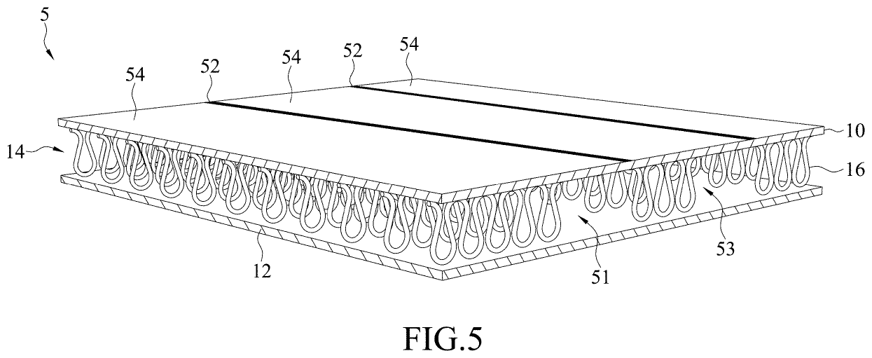

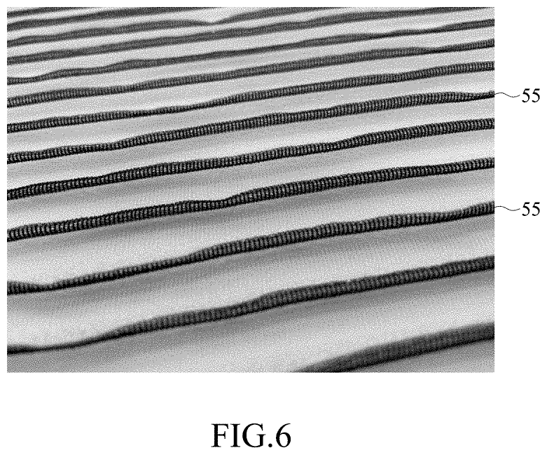

Referring to FIG. 5, a perspective view schematically shows the spacer fabric in accordance with the second preferred embodiment of the present invention. As shown in FIG. 6, a predetermined pattern such as pleats 55 are intended to be formed in the first fabric layer 10. In FIG. 5, using the same reference numerals designate the same or similar elements as shown in FIG. 1. As shown in FIG. 5, channels 51 and 53 are disposed in the middle fabric layer in which there are no wave-like fibers 16. Besides, the first fabric layer 10 is alternately knitted with general-purpose yarns 54 and removable yarns 52. The removable yarns 52 are disposed above the channels 51 and 53. The yarns 52 are the removable yarns that can be completely removed at a subsequent process. After the removable yarn 22 is completely removed at the subsequent process, the general-purpose yarns 54 are separated to form the pleats 55 in the first fabric layer 10, as shown in FIG. 6. The removable yarns 52 can be a water-soluble yarn, alkali-soluble yarn, easily breakable yarn, low melting temperature yarn. Though the pleats 55 are applied to the first fabric layer 10 as shown in FIG. 6, it cannot be construed to limit the scope of the present invention. For the same reason, the pleats 55 can be solely applied to the second fabric layer 12 or simultaneously applied to the first fabric layer 10 and second fabric layer 12.

Although the present invention has been described by the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. A spacer fabric, comprising:
a first fabric layer formed of general-purpose yarns and removable yarns, wherein said general-purpose yarns, and said removable yarns are arranged to a weft-knitted loop construction according to a predetermined pattern;
a second fabric layer; and
a middle fabric layer formed of wave-like fibers interlocked with said first fabric layer and said second fabric layer;
wherein said predetermined pattern appears on the first fabric layer after said removable yarns are removed.

2. The spacer fabric as claimed in claim 1, wherein said removable yarns are selected from a group consisting of water-soluble yarns, alkali-soluble yarns, easily breakable yarns, and low melting temperature yarns.

3. The spacer fabric as claimed in claim 1, further comprising thermally fusible yarns, each of said thermal fusible yarns being adjacently knitted with corresponding one of said removable yarns.

4. The spacer fabric as claimed in claim 1, wherein said predetermined pattern comprises openings formed in the first fabric layer.

5. The spacer fabric as claimed in claim 1, wherein said first, second, and middle fabric layers are knitted by a circular knitting machine.

6. The spacer fabric as claimed in claim 1, wherein said weft-knitted loop construction is a combination of held loops, tuck loops and float loops.

7. A spacer fabric, comprising:
a first fabric layer formed of general-purpose yarns and removable yarns;
a second fabric layer; and
a middle fabric layer having wave-like fibers and channels, said wave-like fibers being interlocked with said first fabric layer and said second fabric layer;
wherein each of said removable yarns is arranged over corresponding one side of said channels according to a predetermined pattern;
wherein said predetermined pattern appears on the first fabric layer after the removable yarns are removed.

8. The spacer fabric as claimed in claim 7, wherein said removable yarns are selected from a group consisting of water-soluble yarns, alkali-soluble yarns, easily breakable yarns, and low melting temperature yarns.

9. The spacer fabric as claimed in claim 7, wherein said predetermined pattern includes pleats.

10. The spacer fabric as claimed in claim 7, wherein said first, second and middle fabric layers are knitted by a circular knitting machine.
